(19) United States
(12) Patent Application Publication
(10) Pub. No.: US 2002/0011499 A1
(43) Pub. Date: Jan. 31, 2002

(54) Sportface

(76) Inventor: Jennifer O'Brien, Orlando, FL (US)

Correspondence Address: Joseph H. McGlynn, 6111 Saddle Horn Dr., Fairfax, VA, 22030, US

(21) Appl. No.: 09/741,185

(22) Filed: Dec. 21, 2000

Related U.S. Application Data
(60) Provisional application No. 60/220,861, filed on Jul. 26, 2000.

(51) Int. Cl. B67D 5/42

(52) U.S. Cl. 222/390; 401/175

(57) ABSTRACT

A dispensing container which has an operating mechanism for dispensing a product in the container, and which has a cap which locks onto the container and which seals the product within the container.

Applicant claims domestic priority of Provisional application S. No. 60/220861, filed Jul. 26, 2000.

### BACKGROUND OF THE INVENTION

This invention relates, in general, to dispenser receptacles, and, in particular, to dispenser receptacles with a lockable and sealable cap.

### DESCRIPTION OF THE PRIOR ART

In the prior art various types of dispenser receptacles have been proposed. For example, U.S. Pat. No. 2,819,556 to Pompa discloses a dispenser having a spring biased plate which forces the contents of the container from the container.

U.S. Pat. No. 1,017,957 to Clark discloses a dispenser having a container and a screw mechanism for pushing out the contents of the container.

U.S. Pat. No. 297,812 to Kibbe discloses a marking implement having a spring biased piston for pushing the contents of the container onto a built in brush.

U.S. Pat. No. 2,284,218 to Livingston discloses a dispensing container having a worm gear operated by a hand wheel to dispense a product inside a container.

### SUMMARY OF THE INVENTION

The present invention is directed to a dispensing container which has an operating mechanism for dispensing a product in the container and which has a cap which locks onto the container and which seals the product within the container.

It is an object of the present invention to provide a new and improved dispensing container.

It is an object of the present invention to provide a new and improved dispensing container which has a built in dispensing mechanism.

It is an object of the present invention to provide a new and improved dispensing container which has a cap which is locked to the container and which seals the product within the container from outside contaminates.

These and other objects and advantages of the present invention will be fully apparent from the following description, when taken in connection with the annexed drawings.

### BRIEF DESCRIPTION OF THE DRAWINGS

FIG. 1 is a side view of the present invention.

FIG. 2 is a perspective view of another embodiment of the present invention.

FIG. 3 is a plan view of another embodiment of the present invention.

FIG. 4 is a plan view of the cap for the embodiment of FIG. 3.

FIG. 5 is a plan view of another embodiment of the present invention.

FIG. 6 is a plan view of the cap for the embodiment of FIG. 5.

FIG. 7 is a perspective view of another embodiment of the present invention.

### DESCRIPTION OF THE PREFERRED EMBODIMENT

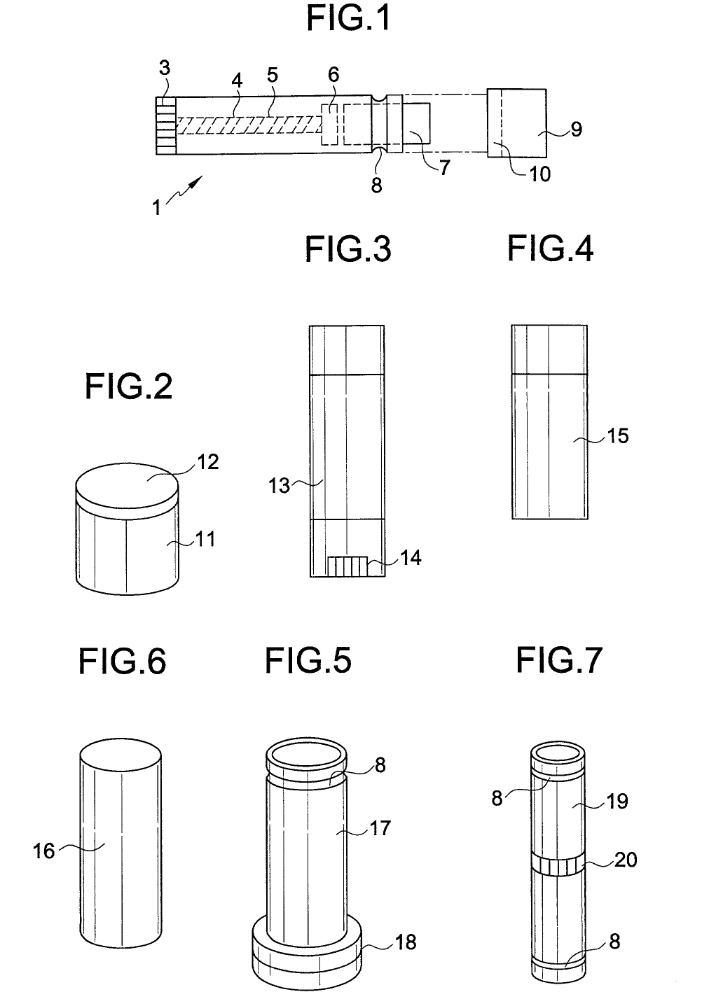

Referring now to the drawings in greater detail, FIG. 1 shows the face paint dispenser 1 of the present invention. It should be noted that the face paint in the dispenser of the present invention is designed to provide sport fans with a safe, non-toxic face paint in their teams colors in a convenient, easy to use packaging. The face paint will come in a variety of colors and can comprise any type of conventional face paint.

As shown in FIG. 1 the dispenser 1 of the present invention comprises a container 2 which has a quantity of face paint 7 contained therein. One end of the container has a operating wheel 3 which is secured to a conventional worm gear 4 which has threads 5 around the circumference of the gear 4. At the top of the gear 4 is a pushing platform 6, which will engage the bottom surface of the face paint 7 and push it out of the container 2 when the wheel 3 is turned. This mechanism is similar to the mechanism disclosed in U.S. Pat. No. 2,284,218 to Livingston, which is hereby incorporated by reference.

The open end of the container (the end that the face paint comes out of) has a groove 8 closely adjacent the top. The cap 9 will fit over the open end of the container 2 and will have an O-ring 10 secured to an internal surface thereof in any conventional manner. When the cap 9 is placed on the container 2, the O-ring 10 will snap into the groove 8 which will serve two purposes. First, it will secure the cap 9 to the container 2 to prevent loss of the cap and to prevent contaminants from deteriorating the face paint 7. Second, it will seal the interior of the container 2 to prevent the face paint from drying out. If the paint dries out it will not be usable to apply a covering of paint to a user's face.

FIG. 2 shows a second embodiment of the present invention which comprises a jar 11 which contains the face paint and a cap 12 which operates similar to the cap 9 of the FIG. 1 embodiment.

FIGS. 3 and 4 show another embodiment of the present invention which comprises a rectangular container 13, a wheel 14 similar to the wheel 3 of the FIG. 1 embodiment, and a cap 15 similar to the cap 9 of FIG. 1. The internal mechanism and the locking groove have not been shown for clarity.

FIGS. 5 and 6 show another embodiment of the present invention which comprises a circular container 17, a wheel 18 similar to the wheel 3 of the FIG. 1 embodiment, and a cap 16 similar to the cap 9 of FIG. 1. The internal mechanism and the locking groove have not been shown for clarity.

FIG. 7 shows another embodiment of the present invention which comprises a circular container 19 and a wheel 20 similar to the wheel 3 of the FIG. 1 embodiment. The operating wheel 20 is positioned away from the end of the container 19. This allows two different colors of face paint to be placed in the same container. When the wheel 20 is turned in one direction, one color of face paint will be dispensed from one end of the container 19. When the wheel 20 is turned in the opposite direction, another color of face paint will be dispensed from the opposite end of the container 19. In this manner, a sports fan will have two team colors in the same container, which can be easily dispensed from the same container. In the FIG. 7 embodiment, two caps, similar to the cap 9 of FIG. 1 will be used to seal the opposite ends of the container 19. The internal mechanism, the caps, and the locking groove have not been shown for clarity.

Although the Sportpaint and the method of using the same according to the present invention has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

1. A dispensing container for face paint, said dispensing container comprising:
a housing having a top, a bottom and sides connecting said top and bottom,
said housing being open at said top, to provide access to an interior of said housing,
a face paint material contained within said housing,
means for dispensing said face paint material from said housing,
means for closing said open top,
said means for closing said open top comprising a cap,
said cap having an inner dimension which is slightly larger than an outer dimension of said housing,
means on said outer dimension of said housing for interacting with means inside said cap for securing said cap to said housing.

2. The dispensing container as claimed in claim 1, wherein said means for dispensing said face paint material from said housing comprises:
a platform positioned within said housing,
said platform engaging a portion of said face paint material,
means for moving said platform from a first position to a second position,
said first position being adjacent said bottom of said housing, and
said second position being adjacent said top of said housing,
means adjacent said bottom of said housing for activating said means for moving said platform from a first position to a second position.

3. The dispensing container as claimed in claim 2, wherein said means for moving said platform, from a first position to a second position, is a worm gear.

4. The dispensing container as claimed in claim 1, wherein said means on said outer dimension of said housing for interacting with said means inside said cap, for securing said cap to said housing, is a groove.

5. The dispensing container as claimed in claim 1, wherein said means inside said cap for securing said cap to said housing is a projection.

6. The dispensing container as claimed in claim 5, wherein said projection is an O-ring.

7. A dispensing container for face paint, said dispensing container comprising:
a housing having a top, a bottom and sides connecting said top and bottom,
said housing being open at said top and open at said bottom to provide access to an interior of said housing,
a face paint material contained within said housing,
a portion of said face paint material adjacent said top being of a first color, and
a portion of said face paint material adjacent said bottom being of a second color,
means for dispensing said face paint material from said housing,
means for closing said open top,
said means for closing said open top comprising caps,
said caps having an inner dimension which is slightly larger than an outer dimension of said housing,
means on said outer dimension of said housing for interacting with means inside said caps for securing said caps to said housing.

8. The dispensing container as claimed in claim 7, wherein said means for dispensing said face paint material from said housing comprises:
a platform positioned within said housing,
said platform engaging said portion of said face paint material, that is adjacent said top, and engaging said portion of said face paint material, that is adjacent said bottom,
means for moving said platform from a first position to a second position,
said first position being adjacent an intermediate portion of said housing, and
said second position being adjacent said top of said housing,
means for moving said platform from a first position to a third position,
said first position being adjacent an intermediate portion of said housing, and
said third position being adjacent said bottom of said housing,
means adjacent said intermediate portion of said housing for activating said means for moving said platform from said first position to said second position, and from said first position to said third position.

9. The dispensing container as claimed in claim 8, wherein said means for moving said platform from said first position to said second position, and from said first position to said third position is a worm gear.

10. The dispensing container as claimed in claim 7, wherein said means on said outer dimension of said housing for interacting with means inside said caps, for securing said caps to said housing, are grooves.

11. The dispensing container as claimed in claim 7, wherein said means inside said caps for securing said caps to said housing is projections.

12. The dispensing container as claimed in claim 11, wherein said projections are O-rings.
